(19) United States
(12) Patent Application Publication
(10) Pub. No.: US 2013/0319379 A1
(43) Pub. Date: Dec. 5, 2013

(54) VALVE WITH PILOT CONTROL, ESPECIALLY FOR A FUEL VAPOR RETENTION SYSTEM

(71) Applicant: A. Kayser Automotive Systems GmbH, Einbeck (DE)

(72) Inventors: Stefan Hettinger, Dannstadt-Schauernheim (DE); Torsten Gerlich, Bensheim (DE)

(73) Assignee: A. Kayser Automotive Systems GmbH, Einbeck (DE)

(21) Appl. No.: 13/908,077

(22) Filed: Jun. 3, 2013

(30) Foreign Application Priority Data
Jun. 4, 2012 (DE) 10 2012 011 051.0

(51) Int. Cl. F16K 31/06; F02M 25/08

(52) U.S. Cl. CPC F16K 31/0655; F02M 25/0836
USPC 123/520; 251/129.07

(57) ABSTRACT

A valve with a pilot control is provided for a fuel vapor retention system. The valve has a main valve (10) with a valve body (12) for opening and closing a fluid passage, a pilot control valve (20), which is arranged at the valve body (12) for opening and closing a channel (14) arranged in the valve body (12) and has an elastically deformable diaphragm (22), and a plunger (30) for pressing the diaphragm (22) against a mouth of the channel (14) to close the channel (14) thereby and displacing the valve body (12) in the closing direction against a valve seat (11).

### BACKGROUND

1. Field of the Invention

The present invention relates to a valve with a pilot control, especially for use as a tank shut-off valve of a fuel vapor retention system. Furthermore, the present invention relates a fuel vapor retention system.

2. Description of the Related Art

Nowadays, fuel vapor generated in a fuel tank of a motor vehicle is no longer discharged to the atmosphere for environmental reasons, but is collected in an activated-carbon container in order to feed the fuel vapor to a suction line and to burn it during the operation of the motor. In order to regenerate or to purge the activated-carbon container, a connecting line between the fuel tank and the activated-carbon container can temporarily be shut off. To this end, corresponding tank shut-off valves which are usually electromagnetically actuated, are arranged in the connecting line between the fuel tank and the activated-carbon container.

Due to the relatively large flow cross-section of such a tank shut-off valve, relatively large actuators are required to ensure a reliable switching operation of the valve in spite of the relatively small pressure difference. It is known in the art, to provide pilot valves with a small flow cross-section in addition to a main valve in order to enable a pressure equalization between an inlet and an outlet of the main valve prior the switching operation. In this way, the force required for the actuator can substantially be reduced. These pilot controlled valves, however, show the drawback that they require numerous components, because a valve of this type consists of two valves and thus requires two valve bodies or valve plates having appropriate biasing means such as springs, and corresponding operating means such as actuators, plunger rods etc.

Therefore, the object of the invention is to provide a compact valve with few components only.

This object is solved by the features of the independent claims. Advantageous embodiments of the invention are defined in the dependent claims.

### SUMMARY OF THE INVENTION

According to the invention, a valve having the following components is provided: a main valve which comprises a valve body or a valve plate or a valve disk for opening and closing a fluid passage, a pilot control valve or a pilot valve, which is arranged at the valve body for opening and closing a channel arranged in the valve body and has an elastically deformable diaphragm, and a plunger for pressing the diaphragm against a mouth of the channel to close the channel and for displacing the valve body in the closing direction in order to press the valve body against a valve seat.

In this context, the term “diaphragm” refers to a plate-like elastic member which on the one hand has the ability of sealing the channel by an abutment at the mouth of the channel, i.e. the ability of an elastic seal. On the other hand, the diaphragm can be bent elastically in order to abut a sealing portion of the diaphragm at the mouth and to move away it therefrom without a complete movement of the entire diaphragm. In other words, an edge portion of the diaphragm is mounted in a substantially fixed manner, while a central sealing portion has the function of a movable valve body or valve plate. The elastic deflection of the diaphragm results in a function as a biasing or spring member.

By the action of a corresponding actuator, the plunger presses the diaphragm against the mouth of the channel, closes the channel thereby and at the same time pushes the valve body towards and abuts it at the valve seat in order to close the main valve. As a consequence, both the pilot control valve and the main valve can be actuated by the same actuating member, i.e. the plunger. It is not required for the pilot valve or pilot control valve to provide a separate actuating member. By further providing the pilot control valve with the elastically deformable diaphragm, the diaphragm can have two functions simultaneously. The diaphragm thus acts as a biasing means such that no separate spring is required for the pilot control valve. Moreover, the diaphragm has the function of the valve body or valve plate for sealing the mouth of the channel. Thus, the pilot control valve has nothing more but the diaphragm as additional component compared to a conventional tank shut-off valve without any pilot or pilot control.

The valve passage having an appropriate valve seat is arranged in the valve body of the main valve. Moreover, the diaphragm has the above-mentioned two functions wherein the plunger for actuating the valve body of the main valve actuates the pilot control valve at the same time. So this pilot-controlled or pilot-operated valve has a very simple structure with a minimal number of components.

Preferably, the diaphragm is elastically resilient for releasing the opening of the channel in the unloaded state.

In this context, a state without any pressure exerted by the plunger is considered as the unloaded state, i.e. the case where the plunger is lifted from and releases the diaphragm. The unloaded state may also be a state where only a fluid pressure acts on the diaphragm while the plunger does not exert any pressure force on the diaphragm. In other words, the return force of the diaphragm is high enough that the diaphragm is deformed to its original shape, even if a fluid pressure acts against the diaphragm.

More preferably, the valve body is forced into the open position by a spring. Thus, without any pressure on the plunger, i.e. without any actuation of an actuator, the valve is kept open or transferred from the closed state into the open state when the plunger is released.

Preferably, the plunger is actuated by an electromagnetic actuator. By this, the valve can electrically be controlled or regulated in order to be actuated by the engine control unit of a motor vehicle when the valve is used as a shut off valve in a fuel vapor retention system

More preferably, the diaphragm comprises rubber or a fuel-resistant and low-temperature flexible elastomer such as fluorosilicone (FVMQ).

Preferably, the valve body comprises a disk in which the channel is arranged, and/or a seal for sealing the valve body with respect to the valve seat. Preferably, the disk has a shape for receiving the seal of the valve body in a positive or form-locking manner for sealing against the seat valve, as well as for receiving the fixed diaphragm in a positive or form-locking manner.

Preferably, the diaphragm is mounted in the valve body in a floating manner, i.e. it is placed in the valve body or the disk. In this position, the diaphragm is held upwardly by the plunger such that no fastening means are required for the diaphragm. To this end, the valve body or plate preferably has a correspondingly shaped receptacle for the diaphragm such as a recessed circular portion or an annular space.

More preferably, the diaphragm comprises a portion having a large diameter and a small thickness and a portion having a smaller diameter and a larger thickness. The portion having a smaller thickness and a larger diameter undergoes a corresponding deflection when pressure is exerted by the plunger for displacing the diaphragm in the direction towards the mouth of the channel. In this case, the portion having the larger diameter is preferably placed in the annular space. In contrast to this, the portion having a smaller diameter and a larger thickness undergoes a small or even no deflection for a substantially flat abutment at the mouth of the channel. In this way, an excellent sealing of the channel is ensured.

Preferably, the valve is used as a tank shut-off valve of a fuel evaporation system of a motor vehicle.

Furthermore, the invention relates to a fuel vapor retention system having an activated-carbon container for absorbing fuel vapor and a valve according to the above description, for selectively opening and closing a connecting line between a fuel container and the activated-carbon container.

In the following, the invention will be explained with reference to an embodiment using the accompanying drawings.

### BRIEF DESCRIPTION OF THE DRAWINGS

FIG. 1 is a cross-section through the valve in the open position.

FIG. 2 shows the cross-section of FIG. 1 in the closed position of the valve.

FIG. 3 shows the cross-section of FIG. 1 in the open position of the pilot control valve and in the still closed position of the main valve.

FIG. 4 shows a schematic diagram for explaining the function of the valve.

### DETAILED DESCRIPTION OF THE PREFERRED EMBODIMENTS

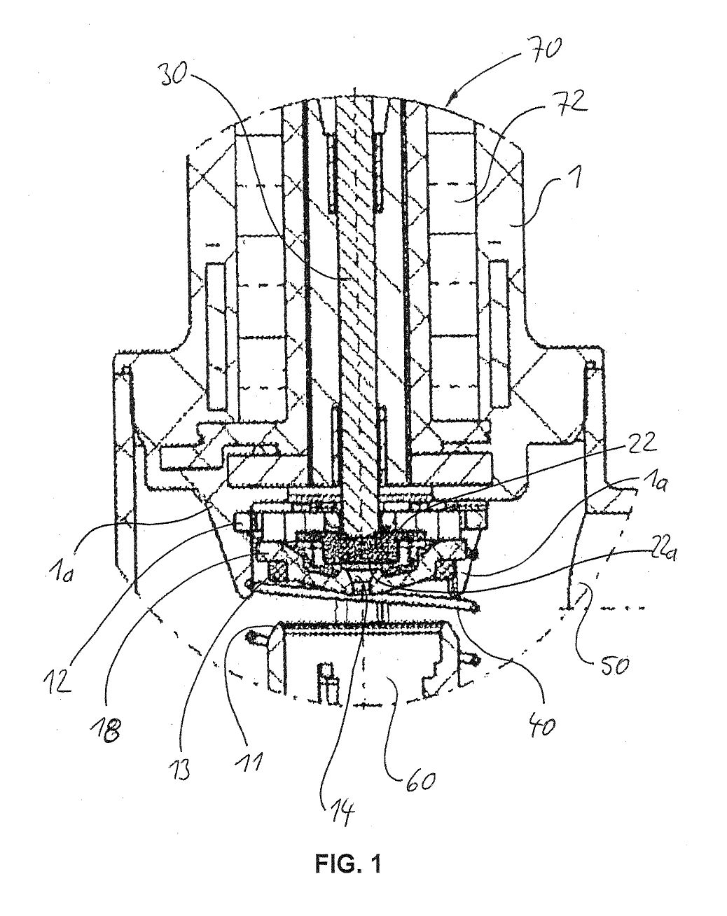

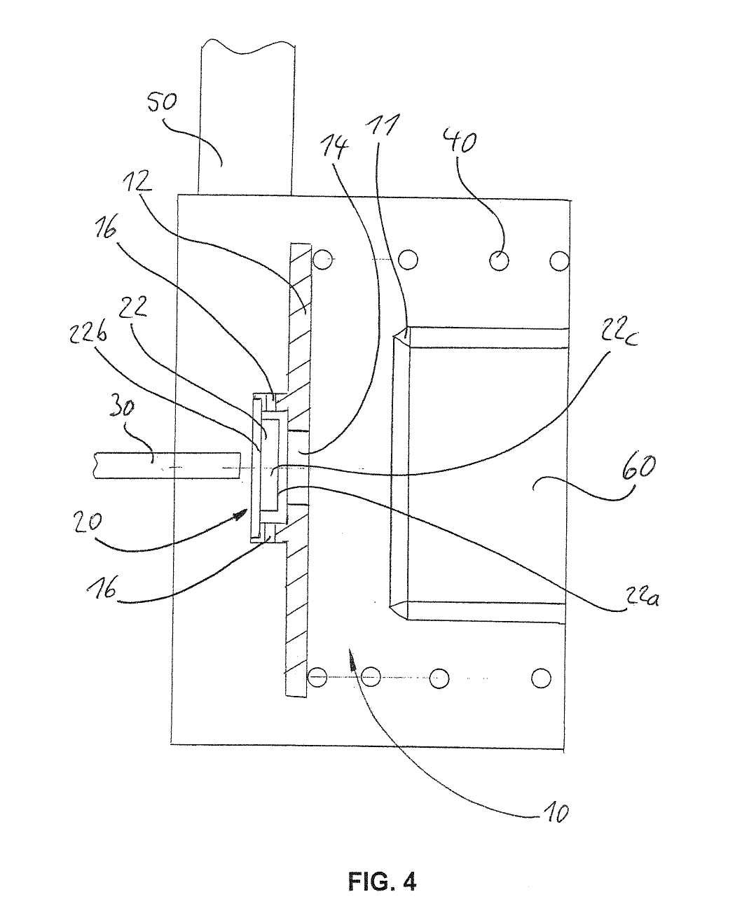

As shown in FIGS. 1 and 4, the valve releases in its open position a fluid passage between a first valve port 50 and a second valve port 60. A valve body 12 can be pressed against a valve seat 11 in order to close the fluid passage of the main valve 10. Moreover, a diaphragm 22 of the pilot control valve 20 can close an opening of a channel 14, which is arranged in the valve body 12 of the main valve 10 in order to prevent a fluid passage through the channel 14.

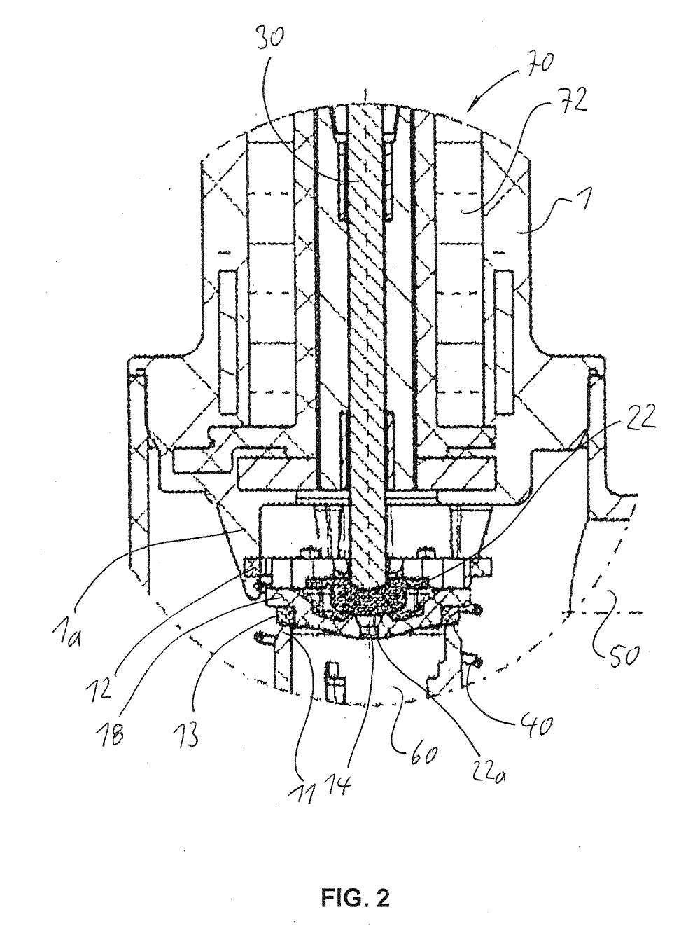

The closed position of the main valve 10 and the pilot control valve 20 is shown in FIG. 2. In order to close the valve, a plunger 30 is pressed against the top of the diaphragm 22 such that the diaphragm 22 deflects and abuts at the mouth of the channel 14 due to the deflection. In this way, the channel 14 is closed by means of a sealing surface 22a of the diaphragm 22 in order to close a fluid passage from the first valve port 50 via openings 16 at the radial periphery of the valve body 12 and the channel 14 to the second valve port 60. Moreover, due to the pressure force exerted by the plunger 30, the valve body 12 is pressed against a biasing force of a spring 40 (lower part in the Figures), in order to abut at the valve seat 11. In this way, the main valve 10 is closed.

In order to open the valve, the pressure force exerted on the plunger 30 is removed such that the diaphragm 22 returns by deformation to its original position due to its elasticity and thus releases the mouth of the channel 14. In this way, the pilot control valve 20 is opened such that the fluid passage from the first valve port 50 via the openings 16 and the channel 14 to the second valve port 60 is released. Due to the release of the fluid passage of the pilot control valve 20, a pressure equalization is enabled between the first valve port 50 and the second valve port 60. In this case, even a weakly constructed spring 40 can lift the valve body 12 from the valve seat 11 in order to open the main valve 10. No large force is required for opening the main valve 10, because substantially no pressure difference between the first and second valve ports 50, 60 must be overcome.

Preferably, a higher pressure is present at the first port 50. The first valve port 50 is therefore connected with a fuel tank (not shown) of a motor vehicle for example, while the second valve port 60 can be connected to an activated-carbon container (not shown) of a fuel vapor retention system. In this case, the diaphragm 22 must have an appropriate elastic return force, in order to be lifted upwards from the first valve port 50 against the exerted pressure in the unloaded state, i.e., in the state where no pressure force is exerted by the plunger 30. In this way, the channel 14 is released from the pressure present at the first valve port 50 due to the elastic return force of the diaphragm 22. Moreover, the spring 40 must have a corresponding bias in order to lift the valve body 12 from the valve seat 11 in a pressure-balanced state, i.e. when the pilot control valve 20 is open.

Since the spring 40 does not have to act against a pressure difference, it can be provided with a small bias or force only. Thus, when the main valve 10 is closed on the other hand, no large forces by an actuator 70 are required either, in order to push the valve body 12 towards the valve seat 11 against the force of the spring 40.

The plunger 30 is actuated by the actuator 70, which is preferably an electromagnetic actuator and accordingly comprises an electromagnet 72, which, when current is supplied, pushes the plunger 30 against the diaphragm 22. Thus, the valve is a so-called 2/2-way solenoid valve of the currentfree and open type. This solenoid valve closes when current is supplied to the electromagnet 72, and opens as soon as current is removed. The term “2/2” denotes a valve having two valve ports and two positions, i.e., the open and closed positions.

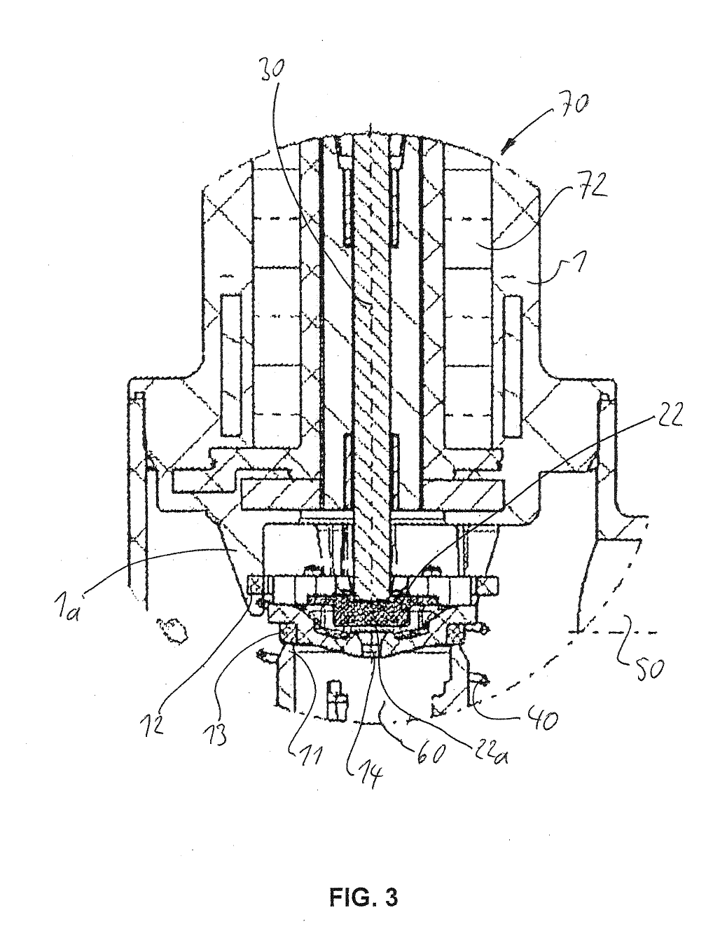

Preferably, the diaphragm 22 is placed in a corresponding portion of the valve body 12 in a positive or form-locking manner only, as shown schematically in FIG. 4. There, a larger-diameter portion 22b of the diaphragm 22 is placed in a corresponding annular space of the valve body 12. In practice, the valve body 12 of the valve preferably comprises a disk 18, as shown in FIGS. 1 to 3, which has the corresponding receptacle of the diaphragm 22. In the figures, the diaphragm is kept upwards by the plunger 30 in the receptacle of the valve body 12 or the receptacle of the disk 18.

Preferably, the diaphragm 22 further includes a portion 22c having a smaller diameter and a larger thickness than the portion 22b having a larger diameter and a smaller thickness. In this way, substantially the larger-diameter portion 22b of the diaphragm 22 deflects when pressure is applied by the plunger 30, while the portion 22c having a smaller diameter and a larger thickness substantially shows no deflection. In this way, the smaller-diameter portion 22c is pressed towards a substantially planar abutment at the mouth of the channel 14 in order to ensure an effective sealing of the channel 14 in the closed position of the pilot control valve 20.

The diaphragm 22 is preferably a correspondingly molded body made of silicone, rubber, natural rubber or a fuel-resistant and low-temperature flexible elastomer such as fluorosilicone (FVMQ).

More preferably, the valve body 12 has at its lower portion a seal 13, which seals the fluid passage of the main valve 10 in co-operation with the valve seat 11. The seal 13 is preferably arranged at the disk 18 as well, which also comprises the channel 14. The seal 13 is preferably also formed of an elastomeric material, such as a fuel-resistant and low-temperature flexible elastomer such as fluorosilicone (FVMQ).

More preferably, the valve body 12 is accordingly guided in a housing 1 of the valve in the radial direction in a way that it can only move in the axial direction, i.e. the longitudinal direction of the plunger 30 and the second valve port 60, between the open position shown in FIG. 1 and the closed position shown in FIG. 2. This guide is preferably formed by projections 1a or depressions which are integrally formed at the housing 1.

The valve described is preferably placed in a connecting line between a fuel tank and an activated-carbon container of a motor vehicle, in order to interrupt the connection between the fuel container and the activated-carbon container temporarily in order to regenerate the activated-carbon container. Normally, the connection is opened via the shut-off valve to feed fuel vapor generated in the fuel tank to the activated-carbon container for absorption.

The use of the described valve as a shut-off valve for a corresponding fuel evaporation and collecting system is not limited thereto. The valve can also be used in other applications, for example as a refueling valve, venting valve, or the like.

What is claimed is:

1. A valve, comprising:
a main valve (10) having a valve body (12) for opening and closing a fluid passage,
a pilot control valve (20) is arranged at the valve body (12) for opening and closing a channel (14) in the valve body (12) and having an elastically deformable diaphragm (22), and
a plunger (30) disposed and configured for pressing the diaphragm (22) against a mouth of the channel (14) to close the channel (14) and for displacing the valve body (12) in a closing direction in order to press the valve body (12) against a valve seat (11).

2. The valve of claim 1, wherein the diaphragm (22) is elastically resilient for releasing the opening of the channel (14) in an unloaded state.

3. The valve of claim 2, wherein the valve body (12) is forced into an open position by a spring (40).

4. The valve of claim 1, wherein the plunger (30) is actuated by an electromagnetic actuator (70).

5. The valve of claim 1, wherein the diaphragm (22) comprises silicone, rubber or a fuel-resistant and low-temperature flexible elastomer.

6. The valve of claim 5, wherein the elastomer is fluorosilicone (FVMQ).

7. The valve of claim 1, wherein the valve body (12) comprises a disk (18) in which the channel (14) is arranged.

8. The valve of claim 1, wherein the valve body further comprises a seal (13) for sealing the valve body (12) with respect to the valve seat (11).

9. The valve of claim 1, wherein the diaphragm (22) is mounted in the valve body (12) in a floating manner.

10. The valve according of claim 1, wherein the diaphragm (22) comprises a portion (22b) having a large diameter and a small thickness and a portion (22c) having a smaller diameter and a larger thickness.

11. A fuel vapor retention system having an activated-carbon container for absorbing fuel vapor and the valve of claim 1 for selectively opening and closing a connecting line between a fuel container and the activated-carbon container.

12. A tank shut-off valve of a fuel evaporation system, the valve comprising:
a main valve (10) having a valve body (12) for opening and closing a fluid passage,
a pilot control valve (20) is arranged at the valve body (12) for opening and closing a channel (14) in the valve body (12) and having an elastically deformable diaphragm (22), and
a plunger (30) disposed and configured for pressing the diaphragm (22) against a mouth of the channel (14) to close the channel (14) and for displacing the valve body (12) in a closing direction in order to press the valve body (12) against a valve seat (11).
